(19) United States
(12) Patent Application Publication
(10) Pub. No.: US 2019/0162927 A1
(43) Pub. Date: May 30, 2019

(54) LENS HOLDING MECHANISM AND IMAGING DEVICE

(71) Applicant: Nidec Copal Corporation, Tokyo (JP)

(72) Inventor: Yuta NAKAMURA, Tokyo (JP)

(73) Assignee: Nidec Copal Corporation, Tokyo (JP)

(21) Appl. No.: 16/313,421

(22) PCT Filed: May 26, 2017
(86) PCT No.: PCT/JP2017/019779

§ 371 Date: Dec. 26, 2018

(30) Foreign Application Priority Data
Jul. 8, 2016 (JP) 2016-136039

(51) Int. Cl. G02B 7/02; G03B 11/00; G03B 17/56

(52) U.S. Cl. CPC G02B 7/021; G03B 11/00; G03B 17/561; G02B 7/023; G02B 7/022

(57) ABSTRACT

A lens holding mechanism is used that has a lens; a lens barrel for securing the lens; a polarizing plate; a flat plate that is secured to the polarizing plate, and that has a protruding portion that protrudes, in respect to the polarizing plate, in a direction that is perpendicular to the optical axial direction; and a polarizing plate holder that is secured in respect to the lens barrel, and that contacts the protruding portion to secure the position of the flat plate. This structure is a structure for reducing stress that acts on a polarizing plate, providing a lens holding mechanism that suppresses the occurrence of screen due to stress.

### CROSS-REFERENCE TO RELATED APPLICATIONS

This application is a National Stage of International Application PCT/JP2017/019779 filed May 26, 2017, which claims priority to Japanese Application No. 2016-136039 filed Jul. 8, 2016. Both documents are incorporated herein by reference in their entirety.

### FIELD OF TECHNOLOGY

One aspect of the present invention relates to a lens holding mechanism and an imaging device (such as a vehicle-mounted camera, or the like).

### BACKGROUND

In recent years, vehicle-mounted cameras have been used broadly, such as in the use of systems wherein a camera is mounted in an automobile to detect obstacles, to thereby avoid hazards. In such imaging devices, such as vehicle-mounted cameras, there are issues with rainwater when there is inclement weather, puddles on road surfaces, and sudden changes in brightness such as in the sunlight when exiting a tunnel, and, as a countermeasure thereto, vehicle-mounted cameras equipped with polarizing plates are used. Japanese Unexamined Patent Application Publication 2015-212742, for example, discloses a camera equipped with such a polarizing plate.

However, in a camera equipped with a polarizing plate of the conventional configuration, set forth above, the polarizing plate may become deformed due to stress that acts on the polarizing plate. When the polarizing plate deforms in this way, this leads to a reduction in quality of the image that is captured.

### SUMMARY OF THE INVENTION

The present invention adopts means such as the following in order to solve the problem described above. Note that while in the explanation below, reference symbols from the drawings in an embodiment, as one example, may be written in parentheses for ease in understanding the present invention, the individual structural elements of the present invention are not limited to those that are written, but rather should be interpreted broadly, in a range that could be understood technically by a person skilled in the art. One means according to the present invention is:

A lens holding mechanism having a lens; a lens barrel for securing the lens; a polarizing plate; a flat plate that is secured to the polarizing plate, and that has a protruding portion that protrudes, in respect to the polarizing plate, in a direction that is perpendicular to the optical axial direction; and

a polarizing plate holder that is secured in respect to the lens barrel, and that contacts the protruding portion to secure the position of the flat plate.

The lens holding mechanism of this configuration enables a reduction in the stresses that act on the polarizing plate, through the polarizing plate being secured by the flat plate and the flat plate being secured by the polarizing plate holder, thereby enabling prevention of deformation of the polarizing plate. In the lens holding mechanism set forth above, preferably: the polarizing plate is disposed on the imaging subject side of the lens.

With the lens holding mechanism set forth above, in the imaging device that is equipped with this lens holding mechanism, the desired optical design (adjustments to the optical path, and the like) may be easier. For example, when there is strain to the degree that it cannot be resolved through the use of a flat plate on the polarizing plate itself, used as a component of the lens holding mechanism, due to, for example, variability in the polarizing plate component, the desired optical design may be satisfied through suppressing, as far as possible, the effects of the strain, through placing the polarizing plate in front of the lens for focusing the light, even when using a polarizing plate that has such strain.

In the lens holding mechanism set forth above, preferably: the polarizing plate is disposed between the flat plate and the lens. In this lens holding mechanism, the polarizing plate is disposed between the flat plate and the lens, enabling prevention of damage to the polarizing plate.

In the lens holding mechanism set forth above, preferably: a polarizing plate holder secures the polarizing plate so as to prevent rotation. Because, with this lens holding mechanism, the polarizing plate is secured by the polarizing plate holder so as to prevent rotation, this enables a feature wherein a change in the direction of polarization, through rotation of the polarizing plate at the time of assembly, is prevented.
In the lens holding mechanism set forth above, preferably: the lens barrel and the polarizing plate holder are formed integrally.

In this lens holding mechanism, the polarizing plate is secured in respect to the lens barrel and the polarizing plate holder, enabling a configuration wherein the position of the lens can be adjusted easily, while the polarizing plate is stationary.

In the lens holding mechanism set forth above, preferably further includes a lens holder for supporting the lens barrel rotatably, in a state prior to securing the position, wherein: the rotation of the polarizing plate holder is constrained by the lens holder.

This lens holding mechanism enables rotation of the lens barrel at the time of assembly, referencing the lens holder, while, on the other hand, the polarizing plate holder is unable to rotate, even during assembly, thus enabling a configuration wherein the direction of polarization by the polarizing plate does not change, while enabling the lens barrel and the lens holder to be connected easily.

Furthermore, the present invention is: an imaging device, with any of the lens holding mechanisms set forth above; and an imaging portion for capturing an image through sensing light that has passed through the polarizing plate and the lens.

This imaging device enables a configuration that suppresses strain of the polarizing plate.

### BRIEF DESCRIPTIONS OF THE DRAWINGS

FIG. 1 is an exterior perspective diagram of an imaging device according to an example.

FIG. 2 is an assembly perspective diagram of an imaging device according to an example.

FIG. 3 is an assembly perspective diagram of a lens unit according to the example.

FIG. 4 is a pre-cited view of a lens unit according to the example.

FIG. 5 is a cross-sectional diagram of a lens unit according to the example.

FIG. 6 is an exterior perspective diagram of an imaging device according to another example.

FIG. 7 is an assembly perspective diagram of an imaging device according to the other example.

FIG. 8 is a two-sided view of a lens unit according to the other example.

FIG. 9 is a cross-sectional diagram of a lens unit according to the other example.

### DETAILED DESCRIPTION

Embodiments according to the present invention will be explained in detail below, referencing the drawings, following the structures below. However, the embodiment explained below is no more than an example of the present invention, and must not be interpreted as limiting the technical scope of the present invention. Note that in the various drawings, identical reference symbols are assigned to identical structural elements, and explanations thereof may be omitted.

The imaging devices in Embodiment 1 and Embodiment 2 have a distinctive feature in the point that the polarizing plate is secured to the flat plate through an adhesive agent, or the like, to secure the position of the flat plate, with the rotation thereof constrained. In particular, the present embodiment differs from Embodiment 2 in the point that the present embodiment is provided with a lens frame, for supporting and securing the lens and the polarizing plate, that is at integrated structure, where in Embodiment 2 the lens barrel and the polarizing plate holder are separate structures. The structure of the imaging device according to the present embodiment will be explained in detail below. Note that in the explanations below, the imaging subject side refers to the side with reference symbol A, shown in each of the figures, and the imaging portion side refers to the side with reference symbol B, shown in these figures. Moreover, in the present invention the structure that includes the lens, the polarizing plate, and the holding structures thereof is termed the “lens unit.”

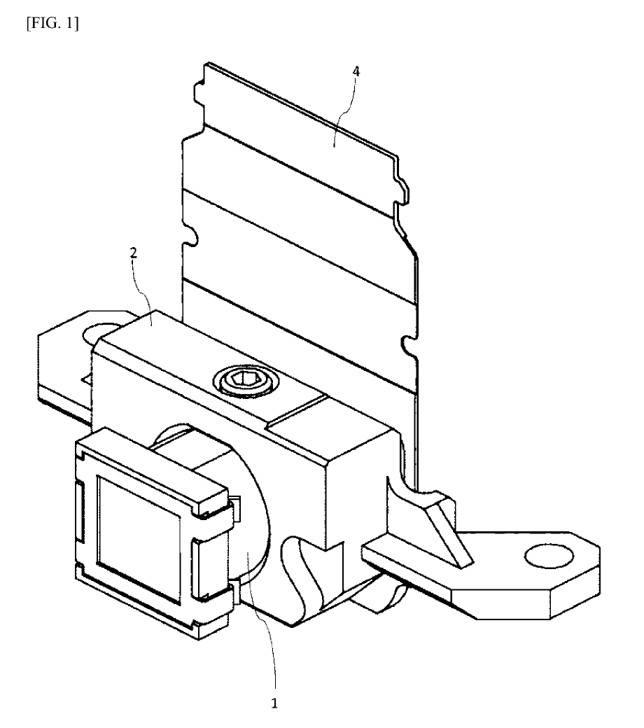

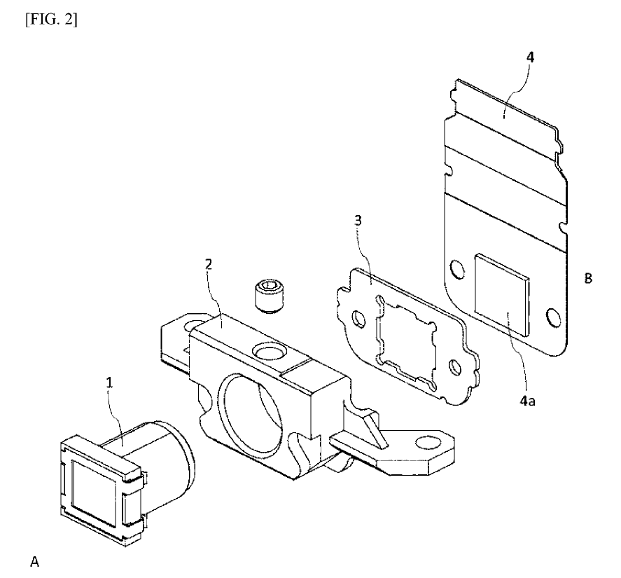

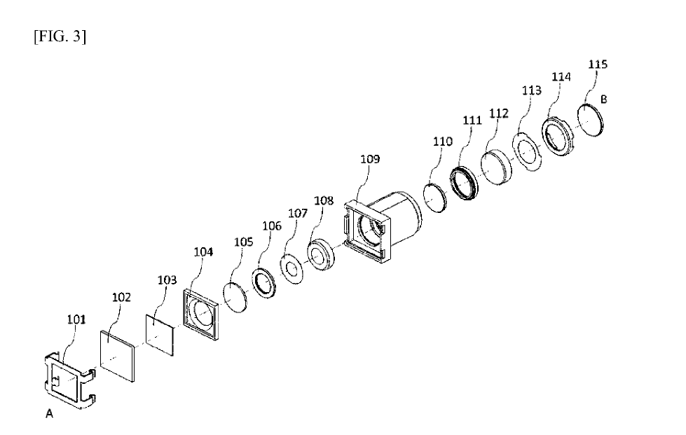

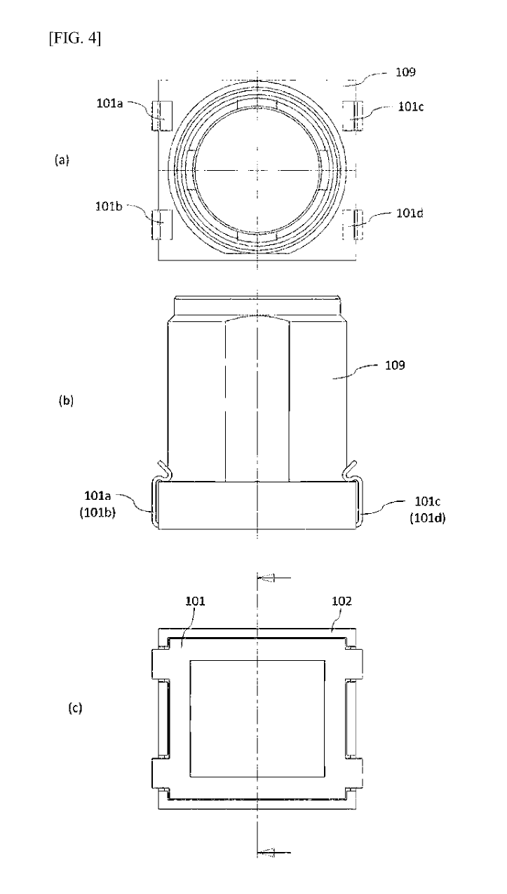

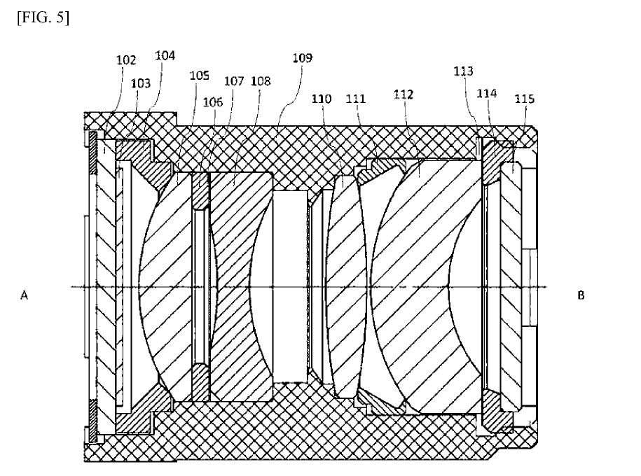

FIG. 1 is an imaging device according to the present embodiment. FIG. 2 is an assembly perspective diagram of the imaging device according to the present embodiment. FIG. 3 is an assembly perspective diagram of a lens unit that includes the imaging device according to the present embodiment. FIG. 4 is an enlarged view of a lens unit that includes an imaging device according to the present embodiment, wherein FIG. 4(a) is a diagram viewed from the imaging portion side, FIG. 4(b) is a side view, and FIG. 4(c) is a diagram viewed from the imaging subject side. FIG. 5 is a cross-sectional view of a lens unit that includes the imaging device according to the present embodiment.
As depicted in FIG. 1 and FIG. 2, the imaging device according to the present embodiment is configured including a lens unit 1, a lens holder 2, sheet metal 3, and a substrate 4. The substrate 4 is, for example, a flexible printed circuit board (FPC), and the imaging element 4a is mounted thereon. The imaging element 4a is a photoelectric inverting element such as, for example, a CCD or CMOS, or the like, but the configuration may instead be provided with an imaging member, such as film, or the like, instead of the imaging element 4a. In the present invention, the structure that is equipped with the imaging function, such as an imaging element, film, or the like, in general is termed the “imaging portion.” The lens holder 2 secures and supports the lens unit 1. In the present invention, the lens holding mechanism refers to the lens unit 1 according to the present embodiment, or a structure that includes the lens unit 1 and a lens holder 2. The imaging device according to the present embodiment, as necessary, is structured including a shutter (for example, a lens shutter, a focal plane shutter, or the like), in addition to the structures that are illustrated. The structures such as the imaging portion, the shutter, and the like, are similar to conventional structures, and thus explanations thereof will be omitted.

### <Lens Unit 1>

As described above, FIG. 3 through FIG. 5 are diagrams depicting a lens unit 1 according to the present embodiment. The lens unit 1, as illustrated, is configured including a flat plate retainer 101, a flat plate 102, a polarizing plate 103, a spacer 104, a first lens 105, a spacer 106, an aperture plate 107, a second lens 108, a lens frame 109, a third lens 110, a spacer 111, a fourth lens 112, an aperture plate 113, a fourth lens retainer 114, and an infrared radiation cut filter 115. As shown in the cross-sectional view in FIG. 5, the configuration is such that each of the structures, such as the lenses, are supported and enclosed by the lens frame 109.
The lens unit 1, as described above, includes a plurality of lenses: the first lens 105, the second lens 108, the third lens 110, and the fourth lens 112. The first lens 105 and the second lens 108 are secured at appropriate positions in the optical axial direction by the lens frame 109, the spacer 104, and the spacer 106. Moreover, the aperture plate 107 is disposed between the spacer 106 and the second lens 108, and constrains, to an appropriate level, the brightness from the imaging subject side. The third lens 110 and the fourth lens 112 are secured at appropriate positions in the optical axial direction by the lens frame 109 and the spacer 111. Moreover, the third lens 110, the spacer 111, and the fourth lens 112 are constrained from movement in the optical axial direction by the fourth lens retainer 114 that is disposed in contact with the fourth lens 112, and is structured so as to screw together with the lens frame 109. The aperture plate 113 is disposed between the fourth lens 112 and the fourth lens retainer 114, to constrain to an appropriate level, together with the aperture plate 107, the brightness from the imaging subject side. The infrared radiation cut filter 115, which cuts (blocks or suppresses) the infrared radiation component (light of a frequency component in the infrared radiation domain) that is included in the light that passes therethrough, is disposed further to the imaging portion side than the fourth lens retainer 114.

### <Lens Frame 109>

The lens frame 109 is structured so as to include the polarizing plate holding part that is formed on the imaging subject side and the lens barrel part that is formed on the imaging portion side. The lens barrel part of the lens frame 109 is structured so as to support, while enclosing, a plurality of lenses including the first lens 105, the second lens 108, the third lens 110, and the fourth lens 112. The polarizing plate holding part of the lens frame 109 is structured so as to support, while constraining the rotation thereof, the flat plate 102 that is adhesively bonded to, and supports, the polarizing plate 103.

### <Support Structure for the Polarizing Plate>

The polarizing plate 103, the spacer 104 that is a structure for supporting and securing the polarizing plate 103, the flat plate 102, and the flat plate retainer 101 are disposed further toward the imaging subject side than the first lens 105.

### <Polarizing Plate 103>

The polarizing plate 103 is a polarizer that is formed in a plate shape so as to transmit only that light, of the light that is incident from the imaging subject side, that is polarized in a specific direction, and to block (or suppress) all other light. While the polarizing plate 103 in the present embodiment is formed in a rectangle, as depicted, the polarizing plate 103 may be formed in an arbitrary shape. The polarizing plate 103 is secured, by an adhesive agent, or the like, to the flat plate 102 at a prescribed rotational position.

### <Flat Plate 102>

The flat plate 102 is formed from glass or resin that is transparent to the incident light, so as to be flat, in is structured so as to support the polarizing plate 103 that is secured by an adhesive agent, or the like. The flat plate 102 is formed so as to be more robust to stress than the polarizing plate 103, through, for example, being formed so as to be thicker than the polarizing plate 103, so as to be able to support the polarizing plate 103 so as to not deform. The flat plate 102 is secured by the flat plate retainer 101. The flat plate 102 is formed so as to have a wider area than the polarizing plate 103, where a protruding portion that protrudes from (extends beyond) the polarizing plate 103, in the direction that is perpendicular to the optical axial direction, is formed thereby. The flat plate 102 is supported, with the rotation thereof constrained, through this protruding portion (extending part), by a rectangular polarizing plate holding part that is formed on the imaging subject side of the lens frame 109. Moreover, a cutout, or the like, is formed in the flat plate 102 so as to prevent an error in the direction of installation of the polarizing plate 103 at the time of assembly.

### <Spacer 104>

The spacer 104 is disposed further to the imaging subject side than the first lens 105, disposed so that there will be a prescribed distance between the first lens 105 and the flat plate 102.

### <Flat Plate Retainer 101>

The flat plate retainer is structured so as to press the flat plate 102 against the lens frame 109 so as to not move in the optical axial direction.

### 2. Embodiment 2

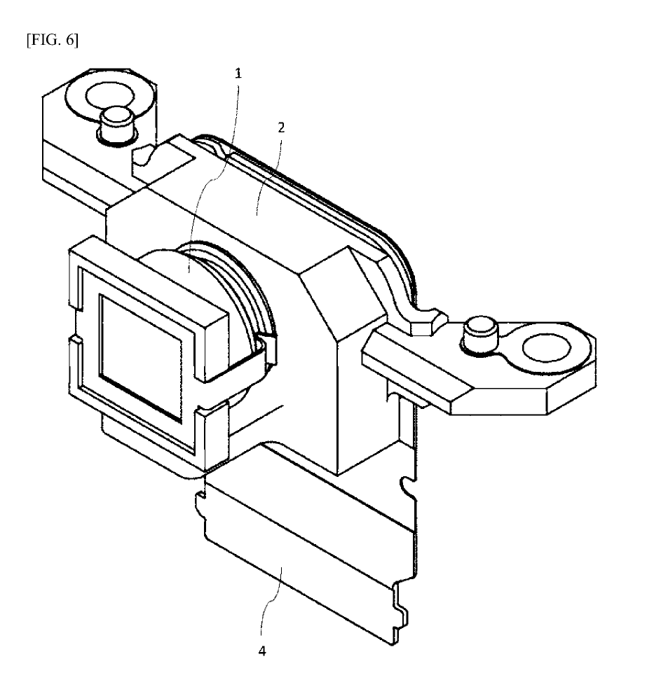

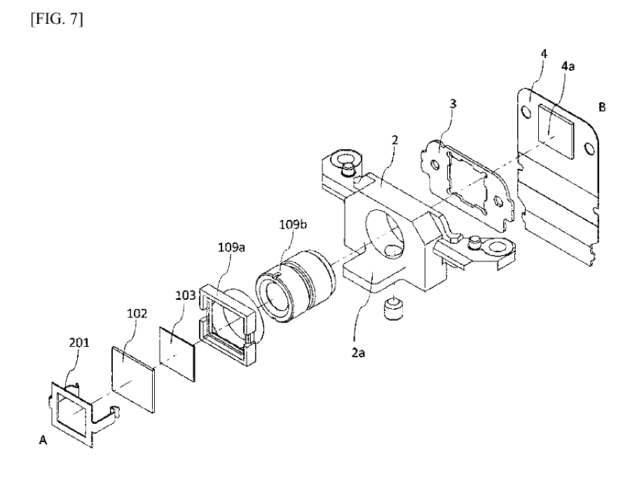

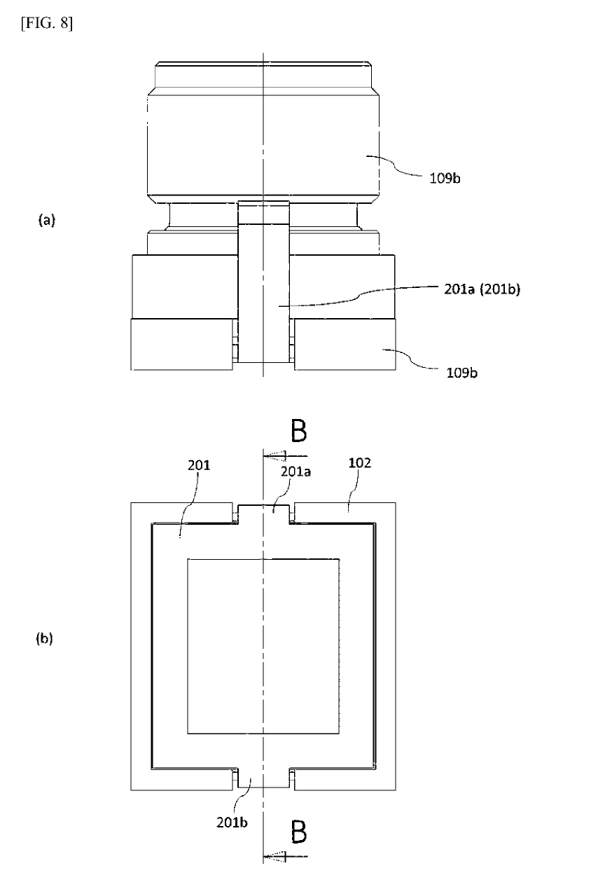

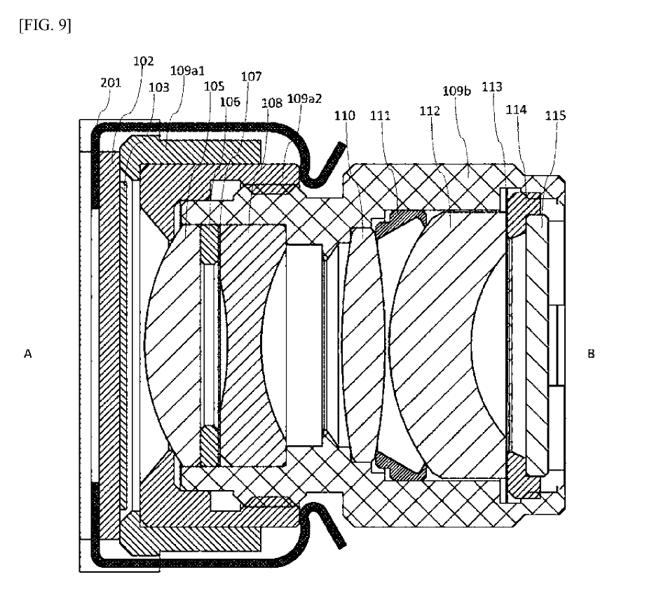

The imaging device according to the present embodiment differs from that of Embodiment 1 in the point that it is structured comprising a lens barrel and a polarizing plate holder, instead of the lens frame, and the point that the lens holder is structured so as to constrain rotation of the polarizing plate. The structure of the imaging device according to the present embodiment will be explained in detail below, focusing particularly on the points of difference from Embodiment 1. Note that, in the description below, explanations regarding those structures that are identical to those in Embodiment 1 will be omitted.
FIG. 6 is an exterior perspective diagram of the imaging device according to the present embodiment. FIG. 7 is an assembly perspective diagram of the imaging device according to the present embodiment. FIG. 8 is an enlarged view of the lens unit (the polarizing plate holder and the lens barrel) of the imaging device according to the present embodiment, wherein FIG. 8(a) is a side view and FIG. 8(b) is a view from the imaging subject side. FIG. 9 is a cross-sectional view of a lens unit (polarizing plate holder and lens barrel) that includes an imaging device according to the present embodiment.
As depicted in FIG. 6 and FIG. 7, the imaging device according to the present embodiment, as with Embodiment 1, is configured including a lens unit 1, a lens holder 2, sheet metal 3, and a substrate 4. The lens unit 1 is structured including a flat plate retainer 201, a flat plate 102, a polarizing plate 103, a polarizing plate holder 109a, and a lens barrel 109b. The structure in the present embodiment wherein the polarizing plate holder 109a and the lens barrel at 109b are formed integrally corresponds to the lens frame 109 of Embodiment 1. The flat plate retainer 201, as with the flat plate retainer 101 in Embodiment 1, is structured so as to press the flat plate 102 against the lens barrel 109b, so as to not move in the optical axial direction.

### <Lens Barrel 109b >

The lens barrel 109b is configured including so as to support and secure a first lens 105, a spacer 106, an aperture plate 107, a second lens 108, a third lens 110, a spacer 111, a fourth lens 112, an aperture plate 113, a fourth lens retainer 114, and an infrared radiation cut filter 115.

### <Polarizing Plate Holder 109a >

As depicted in FIG. 9, while the polarizing plate holder 109a is divided functionally into a polarizing plate supporting portion 109a1 for contacting and supporting the flat plate 102, and a fitting portion 109a2, to be friction fit or screwed to the lens barrel 109b, the polarizing plate supporting portion 109a1 and the fitting portion 109a2 are formed integrally. As with the polarizing plate holding part in Embodiment 1, the polarizing plate holder 109a supports the polarizing plate 103 indirectly, through supporting the flat plate 102 while constraining the rotation thereof.
A polarizing plate holder rotation constraining portion 2a is formed in the lens holder 2. The polarizing plate holder rotation constraining portion 2a contacts the polarizing plate holder 109a to constrain rotation of the polarizing plate holder 109a, and the rotational positioning of the polarizing plate 103, relative to the lens holder 2, is secured thereby. In the imaging device according to the present embodiment, the polarizing plate 103 is secured, so as to not rotate, in respect to the lens holder 2, through the structure set forth above. On the other hand, the lens barrel 109b is friction fit or screwed to the lens holder 2 so as to enable rotation in the state prior to securing, thereby enabling focusing adjustment, in the optical axial direction, prior to product assembly.

### 3. Distinctive Features of Invention

The lens holding mechanisms that include the lens unit 1 in the imaging devices set forth in Embodiment 1 and Embodiment 2, above are both structured comprising: a polarizing plate 103; a flat plate 102 that is secured to the polarizing plate 103, and that has a protruding portion (such as a part that extends further when layered together with the polarizing plate 103) that protrudes, relative to the polarizing plate 103, in a direction that is perpendicular to the optical axial direction; and a polarizing plate holder 109a (or polarizing plate holding part of the lens frame 109), secured to the lens barrel 109b (or lens barrel part of the lens frame 109), for contacting the protruding portion to secure the position of the flat plate 102. Through this, the polarizing plate 103 is secured by the flat plate 102, and the flat plate 102 is secured by the polarizing plate holder 109a (or polarizing plate holding part of the lens frame 109), thus making it possible to reduce the stress that acts on the polarizing plate 103, when compared to a configuration wherein the polarizing plate 103 is supported directly, thereby making it possible to prevent deformation of the polarizing plate 103. By extension, this enables it prevention of a reduction in quality of the image that is captured, which would be caused by the strain in the polarizing plate 103.
Moreover, in the lens holding mechanism of the present invention, the polarizing plate 103 is disposed between the flat plate 102 and the first lens 105, thus enabling prevention of damage to the polarizing plate 103.
Moreover, in the lens holding mechanism according to the present invention, the polarizing plate 103 is secured so as to not rotate, thus enabling a structure that prevents a change in the direction of polarization through rotation of the polarizing plate 103 at the time of assembly.
Moreover, in the lens holding mechanism of Embodiment 1, the lens frame 109 is structured with the lens barrel part and the polarizing plate holding part formed integrally, and thus the polarizing plate 103 is secured in relation to the lens barrel part in the polarizing plate holding part. This enables a structure wherein the position of the lens can be adjusted easily while the polarizing plate 103 is secured.
Moreover, in the lens holding mechanism in Embodiment 2, the lens barrel 109b can rotate, in reference to the lens holder 2, at the time of assembly, while, on the other hand, the polarizing plate holder 109a cannot rotate during assembly, thus enabling a structure wherein the direction of polarization by the polarizing plate 103 does not change, while enabling the lens barrel 109b and the lens holder 2 to be connected easily. Moreover, because this is a structure wherein the optical axial position of the lens that is enclosed in the lens barrel (109b) can be adjusted easily, the focus can be adjusted easily.
Moreover, in the imaging device according to the present invention, the polarizing plate 103 can be disposed at a position that is adjacent to the first lens 105, thus enabling the size of the polarizing plate 103 to be minimized, enabling a reduction in cost, and the like, thereby. This “position that is adjacent” is, for example, a position that satisfies the spacing between the lens and the polarizing plate 103 being between about 0.5 mm and 1 mm (preferably between 0.5 mm and 1 mm).

### 4. Supplementary Items

An embodiment according to the present invention was explained in detail above. The explanation above is no more than an explanation of one form of embodiment, and the scope of the present invention is not limited to this form of embodiment, but rather is interpreted broadly, in a scope that can be understood by one skilled in the art.
For example, while, in the embodiments set forth above, the flat plate 102 and polarizing plate 103 were formed as rectangles, these shapes can be changed arbitrarily. For example, the flat plate 102 and the polarizing plate 103 may instead both be circular shapes or elliptical shapes, or the like, or may be formed instead as squares. However, because it is important that the polarizing plate 103 be installed so as to not be rotated in the direction perpendicular to the optical axis, preferably a structure is used wherein the rotational position is certain, such as through forming a cutout in the structures of each, so that there will be no misalignment of the position wherein the polarizing plate 103 and the flat plate 102 are bonded, or the position wherein the flat plate 102 is secured, to thereby position reliably the rotation of the polarizing plate 103.
Moreover, while in the embodiments set forth above a structure that includes four lenses was used as an example, the number of lenses may be determined arbitrarily, and the numbers and positioning of the spacers and aperture plates can also be changed arbitrarily.
Moreover, the plurality of lenses included in the imaging devices in the embodiments set forth above may use plastic as the raw materials thereof, or may use glass as the raw materials thereof, or may use other transparent materials.
Moreover, preferably the flat plate 102 in the embodiments set forth above is formed so as to be larger (wider) in four directions than the polarizing plate 103, where, in this case, in other words, the outer diameter size of the flat plate 102 is larger than that of the polarizing plate 103. In this case, the extending portion when the flat plate 102 and the polarizing plate 103 are layered together will serve as the protruding portion.
Note that while, in the present invention, the structure comprising the imaging portion and the lens holding mechanism was term the “imaging device,” camera modules are also included in “imaging devices.”
The present invention can be used effectively as, for example, a mechanism for holding a lens equipped with a polarizing plate.

1. A lens holding mechanism comprising:
a lens;
a lens barrel for securing the lens;
a polarizing plate;
a flat plate that is secured to the polarizing plate, and that has a protruding portion that protrudes, in respect to the polarizing plate, in a direction that is perpendicular to the optical axial direction; and
a polarizing plate holder that is secured in respect to the lens barrel, and that contacts the protruding portion to secure the position of the flat plate.

2. The lens holding mechanism as set forth in claim 1, wherein: the polarizing plate is disposed on the imaging subject side of the lens.

3. The lens holding mechanism as set forth in claim 1, wherein: the polarizing plate is disposed between the flat plate and the lens.

4. The lens holding mechanism as set forth in claim 1, wherein: a polarizing plate holder secures the polarizing plate so as to prevent rotation.

5. The lens holding mechanism as set forth in claim 1, wherein: the lens barrel and the polarizing plate holder are formed integrally.

6. The lens holding mechanism as set forth in claim 1, through 5, further comprising:
a lens for supporting the lens barrel rotatably, in a state prior to securing the position, wherein:
the rotation of the polarizing plate holder is constrained by the lens holder.

7. An imaging device, comprising:
a lens holding mechanism as set forth in claim 1, wherein:
an imaging portion for capturing an image through sensing light that has passed through the polarizing plate and the lens.
